(19) United States
(12) Patent Application Publication
(10) Pub. No.: US 2014/0376033 A1
(43) Pub. Date: Dec. 25, 2014

(54) IMAGE FORMATION SYSTEM

(71) Applicant: Sharp Kabushiki Kaisha, Osaka-shi, Osaka (JP)

(72) Inventor: Masato Tokishige, Osaka-shi (JP)

(21) Appl. No.: 14/374,599

(22) PCT Filed: Feb. 7, 2013
(86) PCT No.: PCT/JP2013/052902

§ 371 Date: Jul. 25, 2014

(30) Foreign Application Priority Data
Feb. 15, 2012 (JP) 2012-030294

(51) Int. Cl. G06K 15/00

(52) U.S. Cl. CPC G06K 15/4055
USPC 358/1.14

(57) ABSTRACT

An image formation system includes an image forming apparatus 100 and an extension system 200 each forming an image on recording paper. While the image forming apparatus 100 and the extension apparatus 200 are in a power saving state, when an image forming instruction is received, a control unit of the extension apparatus 200 returns the image forming apparatus 100 and extension apparatus 200 to a normal power consumption state. After receiving the image formation instruction, when an indication of a condition related to image formation is received, the control unit stops power supply to portions not used for image formation executed in accordance with the indication of the condition related to image formation, of the components of image forming apparatus 100 and extension apparatus 200. Thus, power consumption of the image formation system can be reduced without sacrificing the user convenience.

### TECHNICAL FIELD

The present invention relates to an image formation system capable of reducing power consumption without sacrificing user convenience.

### BACKGROUND ART

As one type of image processing apparatuses as electronic equipment, an image forming apparatus (typically a copy machine) for forming an image on a sheet of recording paper has been introduced to many places of business (companies and offices). In such a place of business, it is a common practice to have an image forming apparatus having a printer function or copy function connected to a network and to share the apparatus by a plurality of users. An MFP (MultiFunction Peripheral) as one type of such image forming apparatuses has a plurality of basic operational modes including a copy mode, a facsimile mode (hereinafter facsimile will be also denoted as FAX), a network compatible printer mode and a scanner mode.

A system having a plurality of image forming apparatuses in which the system automatically determines the most suited image forming apparatus to print without necessitating the user to designate an image forming apparatus to be used has been known. By way of example, Japanese Patent Laying-Open No. 2005-11066 (hereinafter referred to as '066 Reference) discloses a system including a plurality of printers connected to a network, in which, when a user requests printing, the printer and the method of printing suitable for print data are automatically selected in accordance with the type of print data. Japanese Patent Laying-Open No. 2001-331292 (hereinafter referred to as '292 Reference) discloses a technique of automatically selecting, in a system including a plurality of printers of different types connected to a network, a printer suitable for a print process in accordance with print conditions.

An image forming apparatus has come to be installed in a public space such as a convenience store, and it provides copying and other multiple services. By way of example, Japanese Patent Laying-Open No. 2010-206617 (hereinafter referred to as '617 Reference) discloses a system in which user convenience is improved by combining an MFP as an electrophotographic type image forming apparatus and a dye-sublimation type image forming apparatus.

In an image forming apparatus having an image forming unit utilizing electro-photography process, a toner image recorded and reproduced on a photoreceptor is transferred to a sheet of recording paper. A heating and fixing unit includes a heat source such as a heater, and it fixes the toner that has been transferred to the sheet of recording paper on the sheet of recording paper by prescribed heat and pressure. Therefore, in order to provide an environment enabling speedy image formation, it becomes necessary to keep constant the temperature of the heating and fixing unit. For this purpose, power conduction to the heat source such as the heater must always be controlled. By way of example, temperature of the roller in the fixing unit is kept at a certain temperature even in a waiting period (so-called ready state), so as to make shorter the time before copying is executed.

Such control naturally increases power consumption. It is quite wasteful to keep the fixing unit warm as described above at a time of day when frequency of use of the copy machine is low. Since the heater requires much electric power, this poses a significant problem from the viewpoint of energy saving.

In view of the foregoing, recently, an image forming apparatus having a function of entering a power saving mode by stopping power supply to a portion or portions consuming much electric power such as the heater in the image forming unit if the image forming apparatus is not used for a given time period or longer has come to be known. Further, an image forming apparatus having a power save key to force the image forming apparatus to enter the power saving mode has come to be known.

### DISCLOSURE OF THE INVENTION

### Problems to be Solved by the Invention

In such a system as disclosed in '617 Reference, operational burden on the user may be reduced by utilizing the techniques disclosed in '066 and '292 References to enable automatic printing by a suitable image forming apparatus, since the system includes a plurality of image forming apparatuses (of electrophotographic type and dye-sublimation type). In a small scale retail store, however, such a measure is insufficient. It must provide printouts quickly to the users and, in addition, it must reduce power consumption by the image forming apparatus or apparatuses to save electricity cost of the store and to save energy, as strongly demanded recently. Particularly, convenience stores and the like are under pressure to simultaneously meet these two conflicting demands.

Therefore, an object of the present invention is to provide an image formation system capable of reducing power consumption without sacrificing the user convenience.

### Means for Solving the Problems

The above-described object can be attained by the following.

Specifically, the present invention provides an image formation system, including: first and second image forming units forming an image on recording paper; a control unit controlling the first and second image forming units; and an input unit receiving an instruction from a user. While the first and second image forming units are in a power saving state, in response to the input unit receiving an image formation instruction as an instruction to form an image on the recording paper, the control unit returns the first and second image forming units from the power saving state to a normal power consumption state, and after receiving the image formation instruction, when the input unit receives an indication of a condition related to the image formation, the control unit causes one of the first and second image forming units, which is not used for the image formation executed in accordance with the indication of the condition, to enter the power saving state.

Preferably, the control unit includes a display unit for displaying an image and a detecting unit for detecting a user operation to the image displayed on the display unit; the control unit receives the indication of the condition by successively displaying a plurality of images on the display unit and detecting a user operation by the detecting unit; and at a time point when one of the first and second image forming units which is not used for the image formation is determined, the control unit causes the determined image forming unit to enter the power saving state.

More preferably, the image formation system further includes a providing unit for providing image data to be used for image formation by the first and second image forming units; and the control unit controls power consumption state of the providing unit. While the providing unit is in the power saving state, in response to the input unit receiving the image formation instruction, the control unit returns the providing unit to the normal power consumption state; and after receiving the image formation instruction, when the input unit receives the indication of the condition, the control unit selectively executes, depending on necessity of the providing unit in image formation in accordance with the indication of the condition, a process of maintaining the providing unit in the normal power consumption state or a process of causing the providing unit to enter the power saving state.

More preferably, the providing unit is a document reading unit reading a document and thereby generating image data, or a reading unit reading image data from a storage medium storing the image data.

Preferably, the image formation system further includes an IC card reader, and the control unit controls power consumption state of the IC card reader. While the IC card reader is in the power saving state, in response to the input unit receiving the image formation instruction, the control unit returns the IC card reader to the normal power consumption state; and after receiving the image formation instruction, when the input unit receives the indication of the condition, the control unit selectively executes, depending on necessity of the IC card reader in image formation in accordance with the indication of the condition, a process of maintaining the IC card reader in the normal power consumption state or a process of causing the IC card reader to enter the power saving state.

More preferably, the first and second image forming units use recording paper of mutually different sizes in image formation; and after receiving the image formation instruction, when the input unit receives the indication of the condition, the control unit determines the size from the indication of the condition, and causes one of the first and second image forming units which does not use the recording paper of the determined size to enter the power saving state.

### Effects of the Invention

By the present invention, when the user inputs an instruction to use the image formation system, the system enters the normal state allowing execution of all functions. Therefore, it is possible for the user to use his/her intended function immediately. Immediately after the function to be executed is decided, the image formation system causes portions related to unused functions to enter the power saving state. Therefore, power consumption can be reduced. Thus, improved usability realized by prompt service and power saving can both be attained without sacrificing the user convenience.

### BRIEF DESCRIPTION OF THE DRAWINGS

FIG. 1 is a block diagram showing a network connection configuration of the image formation system in accordance with an embodiment of the present invention.

FIG. 2 is a front view showing the image forming apparatus and the extension apparatus shown in FIG. 1.

FIG. 3 is a block diagram showing an internal configuration of the image forming apparatus shown in FIG. 1.

FIG. 4 is a block diagram showing an internal configuration of the extension apparatus shown in FIG. 1.

FIG. 5 is a flowchart representing a control structure of a program for reducing power consumption when providing a service, executed in the image formation system shown in FIG. 1.

FIG. 6 is a flowchart representing a control structure of a program executing the service selected in the flowchart of FIG. 5.

FIG. 7 shows a screen image displayed on an operation unit of the image forming apparatus when the image formation system is in a power saving state.

FIG. 8 shows a screen image displayed on the operation unit of the image forming apparatus allowing selection of a service to be provided by the image formation system.

FIG. 9 shows a screen image displayed on the operation unit of the image forming apparatus allowing selection of a photo-print type.

FIG. 10 shows a screen image displayed on the operation unit of the image forming apparatus when a copy service is selected.

### DESCRIPTION OF EMBODIMENTS

In the following embodiment, the same components are denoted by the same reference characters. Their names and functions are also the same. Therefore, detailed descriptions thereof will not be repeated.

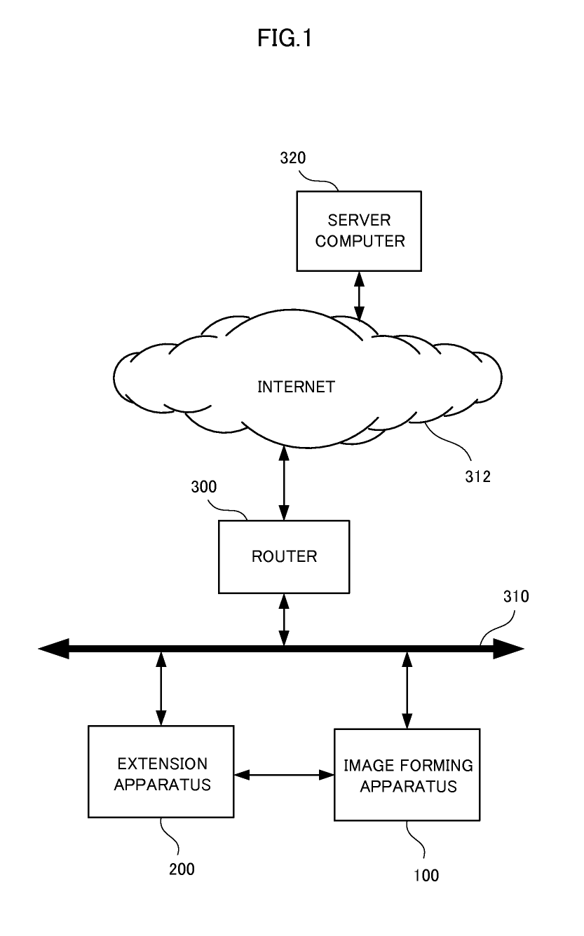

Referring to FIG. 1, the image formation system in accordance with the present embodiment includes an image forming apparatus 100 and an extension apparatus 200. Image forming apparatus 100, extension apparatus 200 and a router 300 are connected to a network 310 such as a LAN. Router 300 manages communication that takes place through network 310. Router 300 is also connected to the Internet 312. A server computer 320 is connected to the Internet 312. By this configuration, image forming apparatus 100 and extension apparatus 200 can communicate with each other through network 310. Further, image forming apparatus 100 and extension apparatus 200 can access server computer 320 through router 300 and the Internet 312. Further, image forming apparatus 100 and extension apparatus 200 are electrically connected to each other and they can exchange specific data with each other directly, not through the network 310. Server computer 320 is under the control of a local government and forms a part of Basic Resident Registration Network. Server computer 320 manages information of Basic Resident Registration and executes, for example, a service of issuing a certificate of residence on-line.

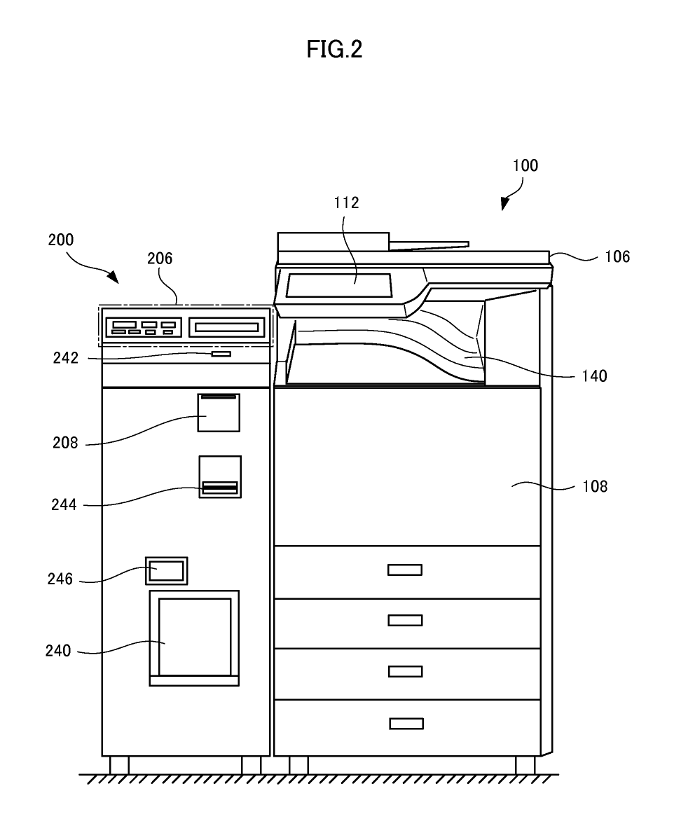

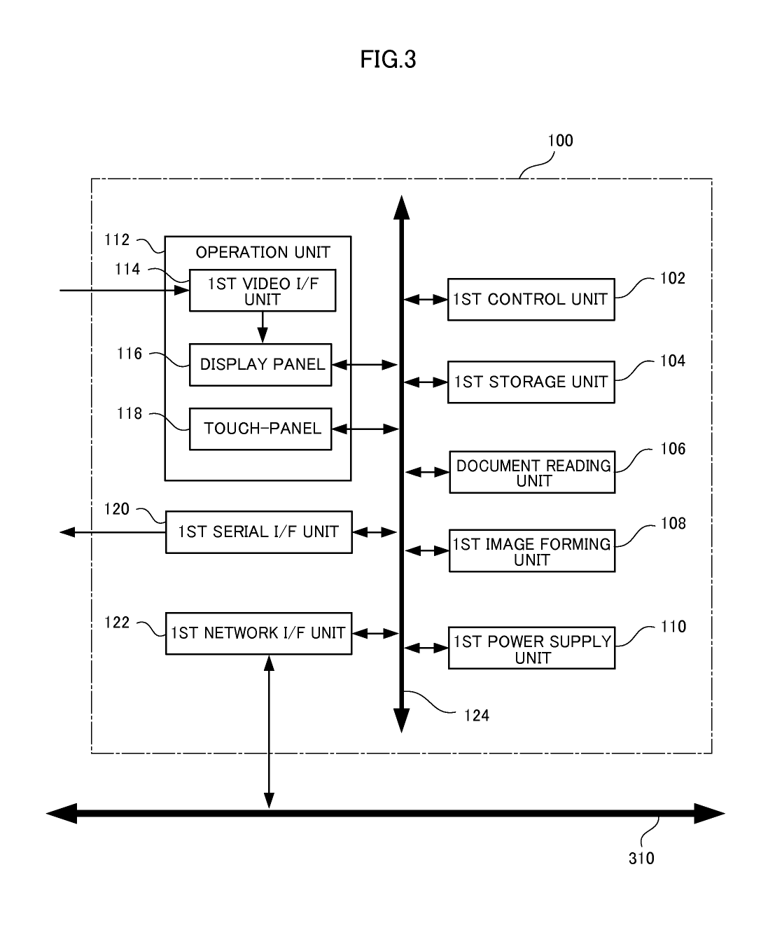

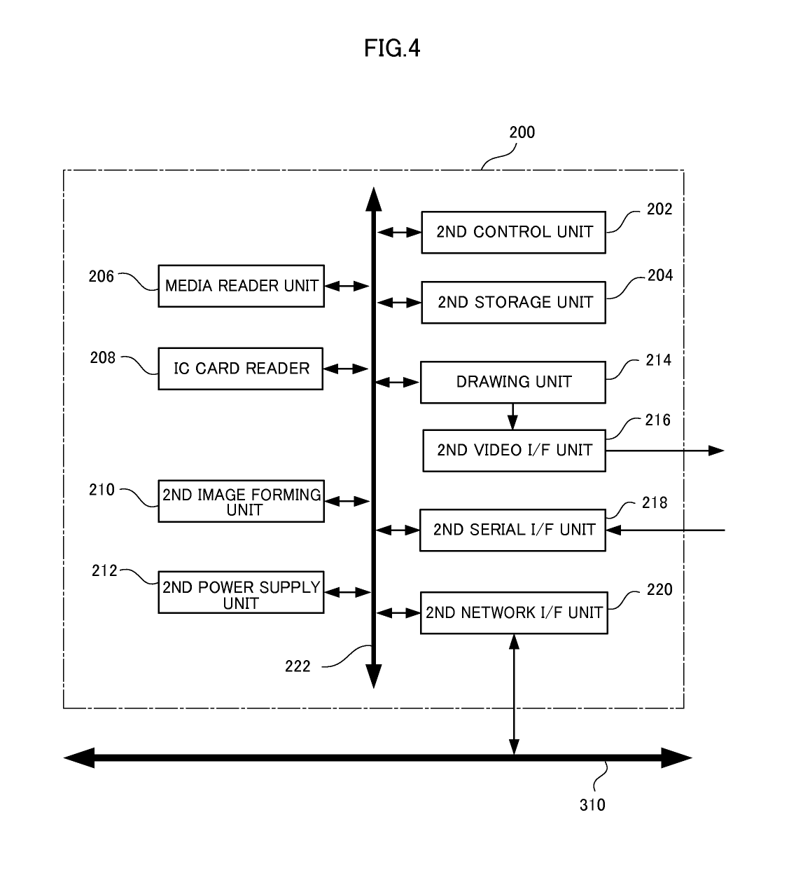

Referring to FIG. 2, image forming apparatus 100 and extension apparatus 200 are installed next to each other. Image forming apparatus 100 is a digital multi-functional peripheral having a plurality of functions including copy, printer and scanner functions. Extension apparatus 200 also has the printer function. Referring to FIGS. 3 and 4, configurations of image forming apparatus 100 and extension apparatus 200 will be described. Since image forming apparatus 100 and extension apparatus 200 include similar components, in order to distinguish such components, terms with “first” and “second” will be used for convenience.

Referring to FIG. 3, image forming apparatus 100 includes a first control unit 102, a first storage unit 104, a document reading unit 106, a first image forming unit 108, a first power supply unit 110, an operation unit 112, a first serial I/F unit 120 and a first network I/F unit 122. Further, image forming apparatus 100 includes a first bus 124, to which these units are connected. Data exchange (including control information) among these units is realized through the first bus 124.

The first control unit 102 is, for example, a CPU (Central Processing Unit). The first storage unit 104 includes a storage device such as an ROM (Read Only Memory), an RAM (Random Access Memory), and an HDD (Hard Disk Drive). The ROM is a non-volatile storage device and it stores programs and data necessary for controlling operations of image forming apparatus 100. The HDD is a rewritable non-volatile storage device, and it stores image data and the like. The RAM is a rewritable volatile storage device. The first control unit 102 reads a prescribed program and prescribed data from the ROM and the HDD to the RAM, and executes the program using a part of RAM as a work area. Image processing on image data and the like is also executed on the RAM. The first control unit 102 is responsible for overall control of image forming apparatus 100 and it realizes each of the functions (copy function, printer function, scanner function and the like) of image forming apparatus 100 in accordance with a program or programs stored in the ROM.

Document reading unit 106 includes a CCD (Charge Coupled Device) for reading an image and a document detection sensor for detecting a document set on a platen or on an automatic document feeder (ADF), and it reads the document and inputs image data. The image data is temporarily stored, for example, in the RAM of first storage unit 104.

The first image forming unit 108 prints image data, which is generated by various image processing operations on the read image data, on a sheet of recording paper fed from a first paper feed unit (not shown) in image forming apparatus 100. The first paper feed unit contains sheets of recording paper of, for example, B5, A4 and A3 sizes (hereinafter also referred to paper of B5-A3 size).

The first power supply unit 110 supplies necessary electric power to various units and parts of image forming apparatus 100 under the control of first control unit 102. In the power saving state as will be described later, the first power supply unit 110 supplies electric power only to prescribed portions and stops power supply to other portions.

Operation unit 112 includes a display panel 116 consisting of a liquid crystal panel or the like, and a touch-panel 118, arranged on display panel 116, for detecting a touched position. Hardware keys such as a power key for turning on/off the power and a power save key causing image forming apparatus 100 to enter the power saving state or to resume the normal state from the power saving state, and an LED lamp lit when the power is on, may be arranged on operation unit 112.

Operation unit 112 receives inputs by a user such as an instruction to image forming apparatus 100. Specifically, a screen image (image) displayed on display panel 116 is generated by a screen image generating unit (not shown) controlled by the first control unit 102. The user takes a look at the screen image and confirms the state of image forming apparatus 100 and processing status of a job. The user can set a function and instruct an operation of image forming apparatus 100 by selecting, through touch-panel 118 arranged on display panel 116, a key displayed in the form of an icon or the like on display panel 116 (touching the corresponding portion on touch-panel 118).

The first control unit 102 monitors the user operation on touch-panel 118 and the hardware keys provided on operation unit 112, and displays information to be notified to the user, such as information related to the state of image forming apparatus 100 on display panel 116, by controlling the screen image generating unit. Operation unit 112 further includes a first video I/F unit 114. The first video I/F unit 114 receives data transmitted through a prescribed cable from extension apparatus 200 and displays a screen image on display panel 116 based on the received data. The displayed screen image includes, as does the screen image generated by screen image generating unit of image forming apparatus 100, a key or keys displayed, for example, in the form of an icon or icons. The first serial I/F unit 120 serially transmits data related to an operation of touch-panel 118 (position data indicating the touched position) to extension apparatus 200 through a prescribed cable, under the control of first control unit 102.

The first network I/F unit 122 is an interface connected to network 310, for enabling image forming apparatus 100 to communicate with an external apparatus through network 310. The first network I/F unit 122 is, for example, an NIC (Network Interface Card).

Referring to FIG. 4, extension apparatus 200 includes a second control unit 202, a second storage unit 204, a media reader unit 206, an IC card reader 208, a second image forming unit 210, a second power supply unit 212, a drawing unit 214, a second video I/F unit 216, a second serial I/F unit 218, and a second network I/F unit 220. Further, extension apparatus 200 includes a second bus 222, to which these units are connected. Data exchange (including control information) among these units is realized through the second bus 222.

The second control unit 202 is, for example, a CPU. Similar to the first storage unit 104, the second storage unit 204 includes a storage device such as an ROM, an RAM and an HDD. The ROM stores programs and data necessary for controlling operations of extension apparatus 200. The second control unit 202 reads a prescribed program and prescribed data from the ROM and the HDD to the RAM, and executes the program using a part of RAM as a work area. Image processing on image data and the like is also executed on the RAM. The second control unit 202 is responsible for overall control of extension apparatus 200 and it realizes each of the functions of extension apparatus 200 in accordance with a program or programs stored in the ROM.

Media reader unit 206 includes a drive for loading an optical disk, and a socket for receiving a portable memory. Data can be read from or written to the loaded optical disk or connected portable memory. The optical disk may include various types of disks such as a CD-R disk and a DVD-RAM disk. The portable memory includes various types of memories such as a USB memory and a flash memory card (SD memory card, memory stick, a compact flash (registered trademark) and the like). Since optical disks and portable memories have different standards, only the optical disk and portable memory acceptable by the drive and socket on the media reader unit 206 can be used. In the following, the optical disk and the portable memory are also generally referred to as “storage medium.”

IC card reader 208 reads data from an IC card in a non-contact manner using, for example, electromagnetic wave, under the control of second control unit 202. Here, the IC card is, for example, a Basic Resident Registration Card (hereinafter referred to as Resident Card) having recorded thereon one's name and resident registration code (personal ID code) described on the certificate of residence.

The second image forming unit 210 prints image data, which is generated by various image processing operations on the image data read from media reader unit 206, on a sheet of recording paper fed from a second paper feed unit (not shown) in extension apparatus 200. The second image forming unit 210 is, for example, a dye-sublimation type printer suitable for photo printing. The second paper feed unit contains sheets of recording paper of, for example, L size (89×127 mm), as the recoding paper commonly used for photo printing.

The second power supply unit 212 supplies necessary electric power to various units and parts of extension apparatus 200 under the control of second control unit 202. In the power saving state as will be described later, the second power supply unit 212 supplies electric power only to prescribed portions and stops power supply to other portions.

Drawing unit 214 generates a screen image (image) to be displayed on display panel 116 of image forming apparatus 100 under the control of second control unit 202. The generated screen image includes, as described above, a key or keys displayed, for example, in the form of an icon or icons. The generated image data is converted to a signal of a prescribed format by the second video I/F unit 216, and transmitted to the first video I/F unit 114 of image forming apparatus 100 through a prescribed cable.

The second serial I/F unit 218 receives data transmitted from the first serial I/F unit 120 of image forming apparatus 100 through a prescribed cable under the control of second control unit 202. As described above, the received data is positional data indicating the touched position of touch-panel 118 of image forming apparatus 100.

The second network I/F unit 220 is an interface connected to network 310, for enabling extension apparatus 200 to communicate with an external apparatus through network 310. The second network I/F unit 220 is, for example, an NIC.

In the following, modes for executing functions (copy function, printer function and scanner function) of image forming apparatus 100 will be briefly described.

(Copy Mode)

When image forming apparatus 100 is used as a copy machine, image data of the document read by document reading unit 106 is output as a copy from the first image forming unit 108.

By the CCD provided at document reading unit 106, images of the document set at a reading position can be electronically read. The read image data is completed as output data (print data) on the RAM of first storage unit 104, and thereafter, the image data is transmitted to the first image forming unit 108 timed with the image formation.

At the first paper feed unit, a sheet of recording paper is drawn by a pick-up roller and conveyed by a plurality of conveyer rollers to the first image forming unit 108. At the first image forming unit 108, a charged photoreceptor drum is exposed in accordance with the input image data, whereby an electrostatic latent image corresponding to the image data is formed on a surface of photoreceptor drum. Toner is applied to the electrostatic latent image portions on the photoreceptor drum and, thereafter, the toner image is transferred by means of a transfer belt to the conveyed sheet of recording paper. Thereafter, the sheet of recording paper is heated and pressed (whereby the image is fixed on the sheet of paper), and then the sheet is discharged to paper discharge tray 140 (see FIG. 2).

(Printer Mode)

When image forming apparatus 100 is used as a printer, image data received through the first network I/F unit 122 from extension apparatus 200 is output from the first image forming unit 108 through the RAM or the like of first storage unit 104. As will be described later, in response to a user instruction, extension apparatus 200 reads prescribed image data from the storage medium connected to media reader unit 206, and transmits the read image data to image forming apparatus 100 through the second network I/F unit 220 and network 310.

Image forming apparatus 100 receives the image data transmitted from extension apparatus 200 through the first network I/F unit 122. The received image data is formed page by page as output image data on the RAM of first storage unit 104 and, as in the copy mode described above, transmitted to the first image forming unit 108, where images are formed.

(Scanner Mode)

When image forming apparatus 100 is used, for example, as a network scanner, image data of the document read at document reading unit 106 is transmitted through the first network I/F unit 122 and network 310 to extension apparatus 200. Here again, the document is electronically read by the CCD provided at document reading unit 106.

Extension apparatus 200 receives the image data transmitted form image forming apparatus 100 through the second network I/F unit 220. As will be described later, the received image data is stored in the storage medium connected to media reader unit 206 and designated by the user.

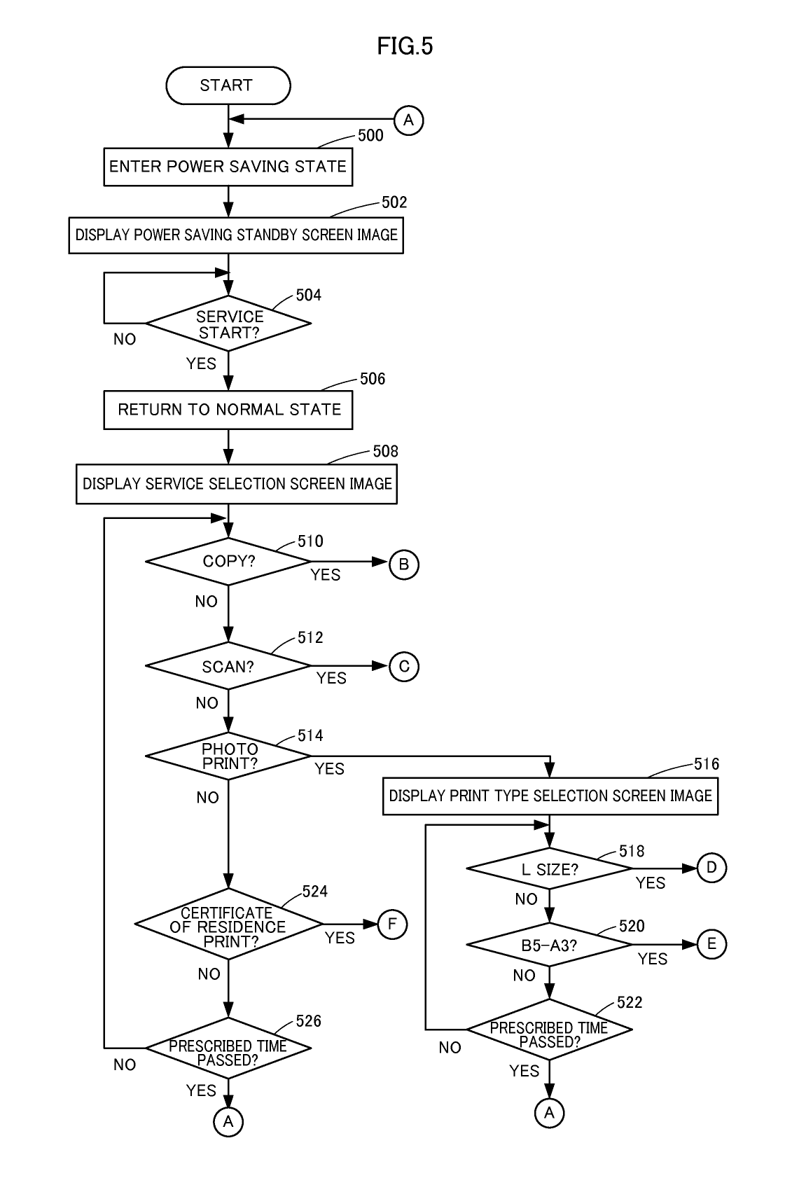

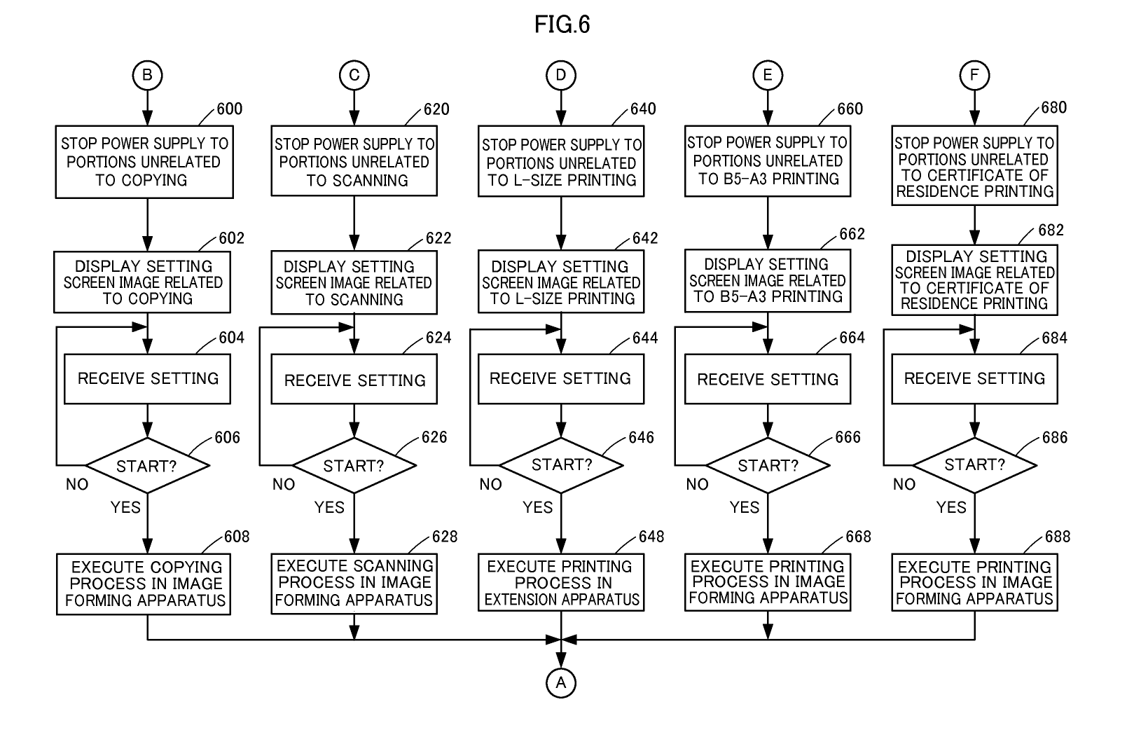

In the following, the control structure of a program for reducing power consumption when the image formation system provides a service will be specifically described with reference to FIGS. 5 and 6. In the following, the normal state means a state in which electric power is supplied to every unit of image forming apparatus 100 and extension apparatus 200 by the first and second power supply units 110 and 212, respectively. The power saving state means a state in which electric power is supplied to the first control unit 102, operation unit 112 and the first serial I/F unit 120 by the first power supply unit 110, electric power is supplied to the second control unit 202 and the second serial I/F unit 218 by the second power supply unit, and power supply to other units is stopped. The normal state is also referred to as the normal mode, and the power saving state is also referred to as the power saving mode or the energy saving mode.

When image forming apparatus 100 and extension apparatus 200 are powered on, at step 500, the second control unit 202 executes warm-up of extension apparatus 200 and, thereafter, causes extension apparatus 200 to enter the power saving state by controlling the second power supply unit 212. The first control unit 102 executes warm-up of image forming apparatus 100 and causes image forming apparatus 100 to enter the power saving state by controlling the first power supply unit 110.

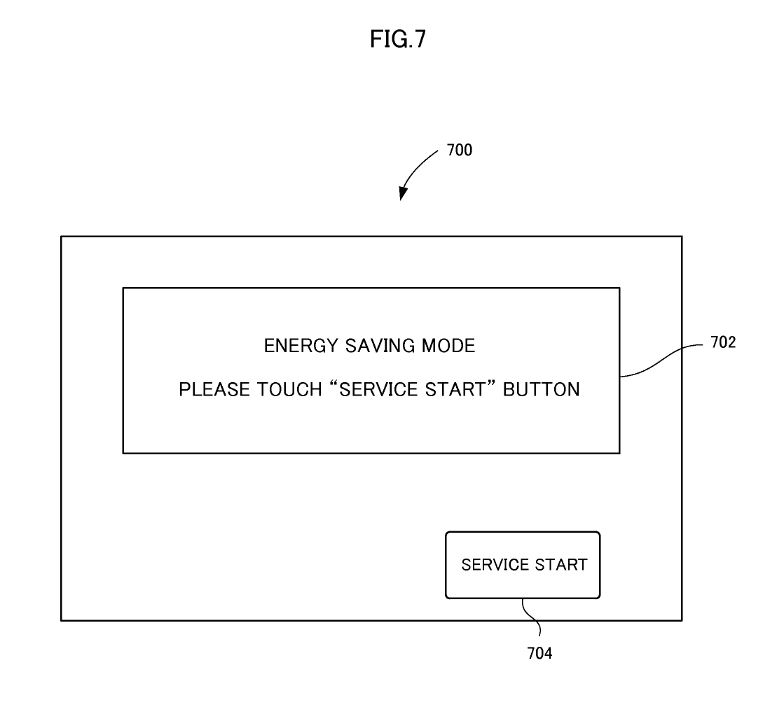

At step 502, the second control unit 202 generates a screen image showing that the image formation system is in the power saving state by controlling drawing unit 214, and displays the screen image on display panel 116 of image forming apparatus 100. Specifically, the second control unit 202 transmits the image data generated by drawing unit 214 through the second video I/F unit 216 to the first video I/F unit 114, as described above. Consequently, an energy saving standby screen image 700 shown in FIG. 7, for example, is displayed on display panel 116. Energy saving standby screen image 700 shown in FIG. 7 includes a message 702 indicating that the image formation system is in the energy saving mode, and a service start key 704.

At step 504, the second control unit 202 determines whether or not the service start key 704 displayed on display panel 116 is touched. Specifically, the second control unit 202 determines whether or not the data (positional data indicating the touched position of touch-panel 118) is received through the second serial I/F unit 218 and, if received, determines whether the received positional data is encompassed in the area of service start key 704 of energy saving standby screen image 700. In this manner, the second control unit 202 determines whether or not the service start key 704 is touched. If it is determined that the service start key 704 is touched, the control proceeds to step 506. Otherwise, step 504 is repeated.

At step 506, the second control unit 202 returns the extension apparatus 200 to the normal state by controlling the second power supply unit 212. Further, the second control unit 202 transmits a prescribed code (hereinafter referred to as “return code”) to the first control unit 102 through the second serial I/F unit 218. Receiving the return code through the first serial I/F unit 120, the first control unit 102 returns image forming apparatus 100 to the normal state by controlling the first power supply unit 110.

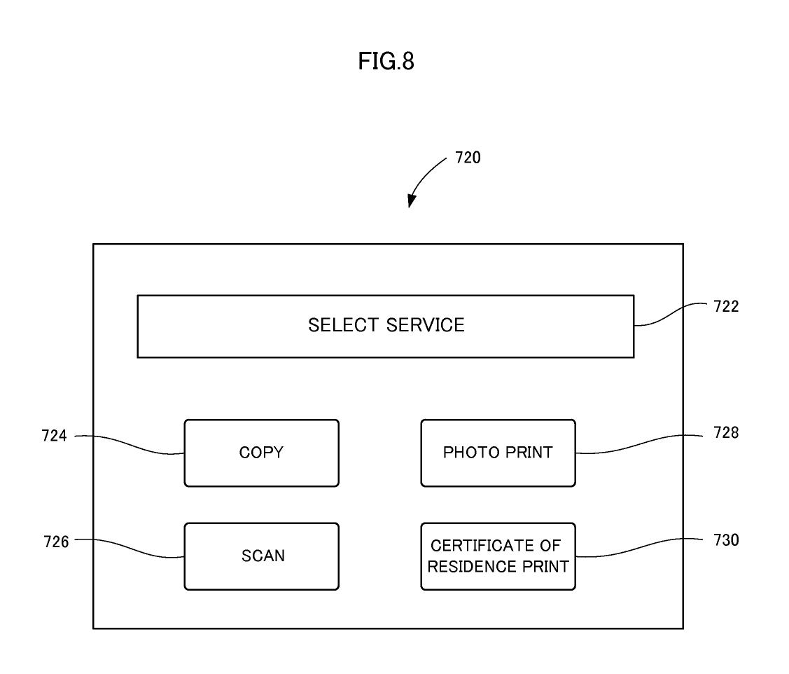

At step 508, the second control unit 202 generates a service selection screen image by controlling drawing unit 214, and displays it on display panel 116 of image forming apparatus 100. Specifically, the second control unit 202 transmits the image data generated by drawing unit 214 from the second video I/F unit 216 to the first video I/F unit 114 as described above. Thus, service selection screen image 720 shown in FIG. 8, for example, is displayed on display panel 116. Service selection screen image 720 of FIG. 8 includes a message 722 notifying the user that selection of a service is possible, and keys (COPY key 724, SCAN key 726, PHOTO PRINT key 728 and CERTIFICATE OF RESIDENCE PRINT key 730) allowing selection of four functions. In response to an operation of any of these keys, image forming apparatus 100 operates in the copy mode, printer mode or scanner mode described above. If PHOTO PRINT key 728 is touched, printing may be executed by extension apparatus 200, as will be described later.

After transmitting service selection screen image 720 to image forming apparatus 100, the second control unit 202 obtains information of current time (hereinafter also simply referred to as current time) from an internal timer (not shown), and stores it in, for example, the RAM of second storage unit 204.

At step 510, the second control unit 202 determines whether COPY key 724 is touched. Specifically, it receives the data (positional data of touch-panel 118) through the second serial I/F unit 218 and determines whether or not the received positional data is within the area of COPY key 724 on service selection screen image 720. In this manner, the second control unit 202 determines whether or not the copy key 724 is touched or not. If it is determined that the COPY key 724 is touched, the control proceeds to step 600 (see FIG. 6). Otherwise, the control proceeds to step 512.

At step 512, in the similar manner as at step 510, the second control unit 202 determines whether or not SCAN key 726 is touched. If it is determined that SCAN key 726 is touched, the control proceeds to step 620 (see FIG. 6). Otherwise, the control proceeds to step 514.

At step 514, in the similar manner as at step 510, the second control unit 202 determines whether or not PHOTO PRINT key 728 is touched. If it is determined that PHOTO PRINT key 728 is touched, the control proceeds to step 516. Otherwise, the control proceeds to step 524.

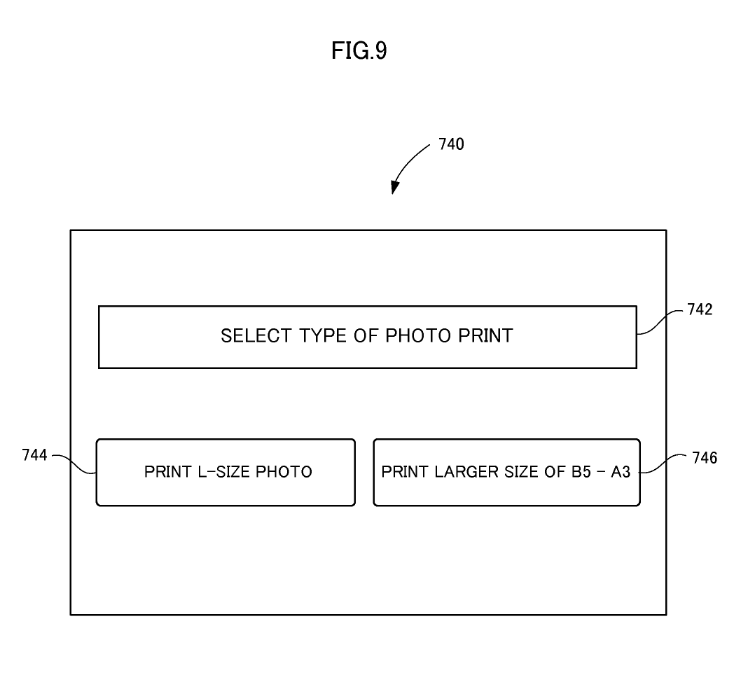

At step 516, the second control unit 202 displays a screen image allowing selection of a type of photo print. The second control unit 202 generates a print type selection screen image by controlling drawing unit 214, and displays it on display panel 116 of image forming apparatus 100. Specifically, the second control unit 202 transmits the image data generated by drawing unit 214 from the second video I/F unit 216 to the first video I/F unit 114 as described above. Thus, print type selection screen image 740 shown in FIG. 9, for example, is displayed on display panel 116. Print type selection screen image 740 shown in FIG. 9 includes a message 742 notifying the user that selection of a type of photo print is possible, and keys allowing selection of two services. Specifically, a key (hereinafter referred to as “L-size print key”) 744 instructing printing on recording paper of L-size (hereinafter referred to as “L-size print process”) and a key (hereinafter referred to as “B5-A3 print key”) 746 instructing printing on recording paper of B5-A3 size (hereinafter referred to as “B5-A3 print process”) are displayed. After transmitting print type selection screen image 740 to image forming apparatus 100, the second control unit 202 obtains current time from the internal timer and stores it in the RAM (in an area different from the area where the time is stored at step 508) of the second storage unit 204.

At step 518, the second control unit 202 determines whether or not L-size print key 744 is touched. Specifically, it receives the data (positional data of touch-panel 118) through the second serial I/F unit 218 and determines whether or not the received positional data is within the area of L-size print key 744 on print type selection screen image 740. In this manner, whether or not the L-size print key 744 is touched or not is determined. If it is determined that L-size print key 744 is touched, the control proceeds to step 640 (FIG. 6). Otherwise, the control proceeds to step 520.

At step 520, in the similar manner as at step 518, the second control unit 202 determines whether or not B5-A3 print key 746 is touched. If it is determined that B5-A3 print key 746 is touched, the control proceeds to step 660 (see FIG. 6). Otherwise, the control proceeds to step 522.

At step 522, the second control unit 202 determines whether or not a prescribed time period set in advance has passed from when print type selection screen image 740 was displayed. Specifically, the second control unit 202 obtains the current time from the internal timer and determines whether difference from the time information stored in the RAM of second storage unit 204 at step 516 is equal to or longer than the prescribed time period.

If it is determined that the prescribed time period has not yet passed, the control returns to step 518. Otherwise, the control returns to step 500. Thus, if PHOTO PRINT key 728 is touched and print type selection screen image 740 is displayed, and thereafter a prescribed time period passes without any valid touching of a key, the image formation system will enter the power saving state by the process of step 500. Thus, wasteful power consumption can be avoided.

At step 524, in the similar manner as at step 510, the second control unit 202 determines whether or not CERTIFICATE OF RESIDENCE PRINT key 730 is touched. If it is determined that CERTIFICATE OF RESIDENCE PRINT key 730 is touched, the control proceeds to step 680 (see FIG. 6). Otherwise, the control proceeds to step 526.

At step 526, the second control unit 202 determines whether or not a prescribed time period set in advance has passed from when service selection screen image 720 was displayed. Specifically, the second control unit 202 obtains the current time from the internal timer and determines whether difference from the time information stored in the second storage unit 204 at step 508 is equal to or longer than the prescribed time period.

If it is determined that the prescribed time period has not yet passed, the control returns to step 510. Otherwise, the control returns to step 500. Thus, if service start key 704 is touched and service selection screen image 720 is displayed, and thereafter a prescribed time period passes without any valid touching of a key, the image formation system will enter the power saving state by the process of step 500. Thus, wasteful power consumption can be avoided.

Through steps 500 to 526 described above, it is possible for the user to select a function to be executed by the image formation system. Execution of a selected function will be described in the following.

If it is determined at step 510 that COPY key 724 is touched, at step 600, the second control unit 202 informs image forming apparatus 100 that the copy is selected, and stops power supply to components not related to the copy process of extension apparatus 200 by controlling the second power supply unit 212. In order to inform the selection of copy to image forming apparatus 100, the second control unit 202 transmits a prescribed code (hereinafter referred to as “copy code”) through the second serial I/F unit 218 to the first control unit 102. Receiving the copy code through the first serial I/F unit 120, the first control unit 102 stops power supply to components not related to copying, by controlling the first power supply unit 110.

Specifically, in extension apparatus 200, power supply to the second image forming unit 210 (dye-sublimation type printer), media reader unit 206 and IC card reader 208 is stopped. Thus, power supply to the heater heating an ink ribbon having solid ink applied thereon in the second image forming unit 210, which consumes much power, is stopped. In image forming apparatus 100, power supply to the first network I/F unit 122 is stopped.

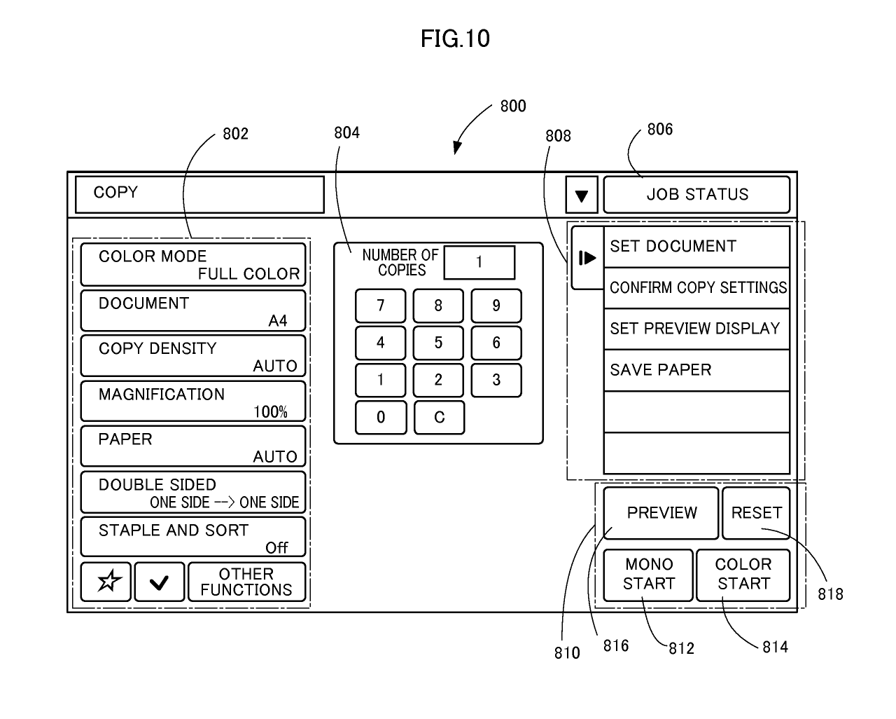

At step 602, the first control unit 102 displays a screen image allowing setting of conditions related to the copy mode, on display panel 116. By way of example, a copy mode setting screen image 800 shown in FIG. 10 is displayed on display panel 116.

Referring to FIG. 10, at an upper left corner of copy mode setting screen image 800, the term “COPY” indicating the copy mode is displayed. At an upper right corner of the screen image, an area 806 indicating the job status is displayed.

In a function selection area 802 of copy mode setting screen image 800, setting keys for setting and changing conditions of various functions and parameters related to the copy mode are displayed. In FIG. 10, from the upper side of function selection area 802, a key for setting whether document data is to be displayed in color or monochrome, a key for changing document size, a key for adjusting density of document data, a key for setting magnification of document data, a key for setting size and type of print paper (recording paper), a key for setting a printing surface of the print paper, and a key for setting stapling of the print result are displayed in this order.

At the lowermost portion of function selection area 802, “OTHER FUNCTIONS” key for requesting display of special functions other than the functions displayed on function selection area 802 is displayed. When any of these keys is touched by the user, a setting screen image (for example, a density setting screen image, an image quality setting screen image, a document setting screen image or the like) is displayed on display panel 116.

At the center of copy mode setting screen image 800, a numerical value entering area 804 for setting the number of copies is displayed. The numerical value entering area 804 includes a key area and a copy number display area. The key area includes numerical keys of “0” to “9” (ten keys) and a clear key (C key). The copy number display area is an area surrounded by a rectangle on the right side of characters “NUMBER OF COPIES”, in which the number of copies input by the user is displayed. FIG. 10 shows an example in which “1” is input as the number of copies. When a PREVIEW key 816, which will be described later, is touched, a preview image of the image data obtained by scanning a document is displayed on the numerical value entering area 804.

On action panel area 808, information related to assistance, guidance and suggestions for operations is displayed. When a specific function is selected, a function or functions related to the selected function may be displayed on action panel area 808.

On task trigger area 810, a MONO START key 812, a COLOR START key 814, a PREVIEW key 816 and a RESET key 818 are displayed. MONO START key 812 and COLOR START key 814 are for scanning a document and starting monochrome and color printing, respectively. PREVIEW key 816 is for starting scanning of a document. When PREVIEW key 816 is touched, a document is scanned, a preview image based on the scanned data is generated and displayed at the center (an area including numerical value entering area 804) of the screen image. RESET key 818 is for cancelling all functions and parameters of which settings have been changed, and thereby returning the settings to a default state.

At step 604, the first control unit 102 detects a touch operation on touch-panel 118, specifies a key displayed on the screen image that corresponds to the touched position, and executes a corresponding process (including display of a further setting screen image). In this manner, the first control unit 102 receives settings of conditions related to copying.

At step 606, the first control unit 102 determines whether MONO START key 812 or COLOR START key 814 of task trigger area 810 is touched. If it is determined to be touched, the control proceeds to step 608. Otherwise, the control returns to step 604.

At step 608, the first control unit 102 executes a copy process in accordance with the set conditions. Specifically, the first control unit 102 scans a document by controlling document reading unit 106, processes obtained image data, forms an image on recording paper and discharges the paper to a discharge tray 140. Thereafter, the control returns to step 500.

If it is determined at step 512 that SCAN key 726 is touched, at step 620, the second control unit 202 notifies image forming apparatus 100 that scanning is selected, and stops power supply to components not related to scanning of extension apparatus 200 by controlling the second power supply unit 212. In order to notify image forming apparatus 100 of the selection of scanning, for example, the second control unit 202 transmits a prescribed code (hereinafter referred to as a “scan code”) to the first control unit 102 through the second serial I/F unit 218. Receiving the scan code through the first serial I/F unit 120, the first control unit 102 stops power supply to components not related to the scanning process, by controlling the first power supply unit 110.

Specifically, in extension apparatus 200, power supply to the second image forming unit 210, IC card reader and the like, for example, is stopped. In image forming apparatus 100, power supply to the first image forming unit 108 is stopped. Thus, power supply to the fixing heater of first image forming unit 108 and the heater of second image forming unit 210, which consume much power, can be stopped.

At step 622, the first control unit 102 displays, on display panel 116, a screen image for setting conditions related to the scanning mode and designating a storage medium for storing the scanned image. Settings for the scanning mode includes monochrome scanning, color scanning, scanning resolution, scanning area and the like, and the screen image for setting these is displayed on display panel 116.

Designation of a storage medium may be realized by displaying, on display panel 116, a list of storage media mounted on media reader unit 206, and allowing selection therefrom. The screen image displaying the list of storage media may be generated, for example, by the first control unit 102. If the second control unit 202 detects the attached each storage medium by controlling media reader unit 206 and transmits information representing the detected each storage medium through the second serial I/F unit 218 to the first control unit 102, the first control unit 102 can generate a screen image displaying the list of storage media based on the received information. Alternatively, the second control unit 202 may cause drawing unit 214 to generate the screen image displaying the list of storage media, and transmit it to image forming apparatus 100 through the second video I/F unit 216, as described above. In that case, the second control unit 202 also transmits positional information for specifying the selection area on the screen image to display the list of storage media, to the first control unit 102.

At step 624, the first control unit 102 detects a touch operation on touch-panel 118, specifies a key displayed on the screen image that corresponds to the touched position, and executes a corresponding process (including display of a further setting screen image). In this manner, the first control unit 102 receives settings of scanning and designation of the storage medium for storing the scanned image.

At step 626, the first control unit 102 determines whether a start key for starting scanning is touched. If it is determined to be touched, the control proceeds to step 628. Otherwise, the control returns to step 624.

At step 628, the first control unit 102 executes the scanning process in accordance with the set conditions, and transmits the obtained image data to extension apparatus 200. Specifically, the first control unit 102 scans a document by controlling document reading unit 106, and transmits the obtained image data and the information specifying the storage medium through the first network I/F unit 122 to extension apparatus 200. Receiving the data from image forming apparatus 100, extension apparatus 200 (second control unit 202) stores the received image data as an image file with a specific name, in the storage medium specified by the information specifying the storage medium. Then, the control returns to step 500.

If it is determined at step 518 that L-size print key 744 is touched, at step 640, the second control unit 202 notifies image forming apparatus 100 that the L-size print process is selected, and stops power supply to components not related to the L-size print process of extension apparatus 200. In order to notify image forming apparatus 100 of the selection of L-size print process, the second control unit 202 transmits a prescribed code (hereinafter referred to as “L-size print code”) through the second serial I/F unit 218 to the first control unit 102. Receiving the L-size print code through the first serial I/F unit 120, the first control unit 102 stops power supply to components not related to the L-size print process, by controlling the first power supply unit 110.

Specifically, in extension apparatus 200, power supply to IC card reader 208 and to the second network I/F unit 220 is stopped. In image forming apparatus 100, power supply to the first image forming unit 108, document reading unit 106 and the second network I/F unit 220 is stopped. Thus, power supply to the fixing heater of first image forming unit 108, which consumes much power, is stopped.

At step 642, the second control unit 202 displays a screen image for designating the storage medium that stores the image data to be printed, for designating an image or images to be printed among the images stored in the storage medium, and for setting conditions related to the L-size print process, on display panel 116 of image forming apparatus 100. Designation of a storage medium may be realized by displaying, on display panel 116, a list of storage media mounted on media reader unit 206, and allowing selection therefrom. The screen image displaying the list of storage media may be generated, for example, by the second control unit 202. The second control unit 202 detects the attached storage media by controlling media reader unit 206, causes drawing unit 214 to generate information representing the detected storage media, and transmits it through the second video I/F unit 216 to image forming apparatus 100, as described above.

The screen image for designating the image or images to be printed from among the images stored in the storage medium is displayed after the storage medium is designated. By way of example, the second control unit 202 reads information of stored image files from the designated storage medium by controlling media reader unit 206, causes drawing unit 214 to generate a screen image displaying, as a list, information representing the image files (for example, file names), and transmits it through the second video I/F unit 216 to first image forming apparatus 100 as described above.

Settings of conditions related to the L-size print process include a rectangular area to be printed of the designated image, resolution of print image and designation of monochrome or color print. The screen image allowing setting of these is displayed on display panel 116. The L-size print process is a process for printing the designated area of designated image fully on the recording paper of L-size. It is noted that the first control unit 102 may cause the screen image generating unit to generate these screen images and to display on display panel 116. In that case, the second control unit 202 transmits necessary information to the first control unit 102.

At step 644, the second control unit 202 detects a touch operation on touch-panel 118, specifies a key displayed on the screen image that corresponds to the touched position, and executes a corresponding process (including display of a further setting screen image). In this manner, the second control unit 202 receives designation of the storage medium that stores the image data to be printed, designation of the image or images to be printed among the images stored in the storage medium, and setting conditions related to the L-size print process.

At step 646, the second control unit 202 determines whether or not the start key for starting the L-size print process is touched. If it is determined to be touched, the control proceeds to step 648. Otherwise, the control returns to step 644.

At step 648, the second control unit 202 executes the L-size print process in accordance with the set conditions. Specifically, the second control unit 202 reads the designated image data from the designated storage unit by controlling media reader unit 206, processes the read image data, conveys recording paper of L-size to the second image forming unit 210 by controlling a mechanism for conveying the recording paper of L-size, prints the image under the designated conditions on the recording paper of L-size, and discharges the paper to a photo discharge unit 240. Thereafter, the control returns to step 500.

If it is determined at step 520 that B5-A3 print key 746 is touched, at step 660, the second control unit 202 notifies image forming apparatus 100 that the B5-A3 print process is selected, and stops power supply to components not related to the B5-A3 print process of extension apparatus 200 by controlling the second power supply unit 212. In order to notify image forming apparatus 100 of the selection of B5-A3 print process, the second control unit 202 transmits a prescribed code (hereinafter referred to as “B5-A3 print code”) through the second serial I/F unit 218 to the first control unit 102. Receiving the B5-A3 print code through the first serial I/F unit 120, the first control unit 102 stops power supply to components not related to the B5-A3 print process, by controlling the first power supply unit 110.

Specifically, in extension apparatus 200, power supply to the second image forming unit 210 and IC card reader 208 is stopped. In image forming apparatus 100, power supply to the document reading unit 106 is stopped. Thus, power supply to the heater of second image forming unit 210, which consumes much power, is stopped.

At step 662, the second control unit 202 displays a screen image for designating the storage medium that stores the image data to be printed, for designating an image or images to be printed among the images stored in the storage medium, and for setting conditions related to the B5-A3 print process, on display panel 116 of image forming apparatus 100. The screen image for designating the storage medium and designating the image or images in the designated storage medium can be displayed on display panel 116 in the similar manner as step 642 for the L-size print process and, therefore, accumulative description will not be repeated.

As to the setting of conditions related to the B5-A3 print process, the second control unit 202 may cause drawing unit 214 to generate a screen image similar to that of FIG. 10, for example, and by transmitting it to image forming apparatus 100 through the second video I/F unit 216 and displaying on display panel 116, setting can be done in the manner as described above. Such screen images may be generated by the first control unit 102. In that case, the second control unit 202 transmits necessary information to the first control unit 102.

At step 664, the second control unit 202 detects a touch operation on touch-panel 118, specifies a key displayed on the screen image that corresponds to the touched position, and executes a corresponding process (including display of a further setting screen image). In this manner, the second control unit 202 receives designation of the storage medium that stores the image data to be printed, designation of the image or images to be printed among the images stored in the storage medium, and setting conditions related to the B5-A3 print process.

At step 666, the second control unit 202 determines whether or not the start key for starting the B5-A3 print process is touched. If the start key is determined to be touched, the control proceeds to step 668. Otherwise, the control returns to step 664.

At step 668, the second control unit 202 executes the B5-A3 print process in accordance with the set conditions. Specifically, the second control unit 202 reads the designated image data from the designated storage unit by controlling media reader unit 206, and transmits a print job including the read image data and the conditions related to the B5-A3 print process through the second network I/F unit 220 to image forming apparatus 100. Receiving the print job through the first network I/F unit 122, the first control unit 102 processes the received image data in accordance with the designated conditions and generates the image data for printing. Thereafter, the first control unit 102 forms an image on a sheet of recording paper using the image data for printing, by controlling the first image forming unit 108. Thereafter, the control returns to step 500.

If it is determined at step 524 that CERTIFICATE OF RESIDENCE PRINT key 730 is touched, at step 680, the second control unit 202 notifies image forming apparatus 100 that the certificate of residence print process is selected, and stops power supply to components not related to the certificate of residence print process of extension apparatus 200 by controlling the second power supply unit 212. In order to notify image forming apparatus 100 of the selection of certificate of residence print process, the second control unit transmits a prescribed code (hereinafter referred to as “certificate of residence print code”) through the second serial I/F unit 218 to the first control unit 102. Receiving the certificate of residence print code through the first serial I/F unit 120, the first control unit 102 stops power supply to components not related to the certificate of residence print process, by controlling the first power supply unit 110.

Specifically, in extension apparatus 200, power supply to the second image forming unit 210 and media reader unit 206 is stopped. In image forming apparatus 100, power supply to the document reading unit 106 is stopped. Thus, power supply to the heater of second image forming unit 210, which consumes much power, is stopped.

At step 682, the second control unit 202 displays a setting screen image related to the certificate of residence print process. The certificate of residence print process is a service for providing on-line a copy of certificate of residence managed by a local government. To receive the service, Resident Card distributed by the local government to residents is necessary. The second control unit 202 causes drawing unit 214 to generate image data including, for example, a message “Reading of resident registration code is necessary. Please hold your Resident Card over the card reader” and transmits the generated image data through the second video I/F unit 216 to image forming apparatus 100. Thus, the message asking the user to enter the resident registration code using the Resident Card is displayed on display panel 116.

At step 684, the second control unit 202 receives the resident registration code from the Resident Card (IC card) through IC card reader 208, and displays a screen image for entering a personal identification number and a screen image for designating conditions for the copy of certificate of residence the user desires, on display panel 116. In this state, the second control unit 202 detects a touch operation on touch-panel 118, specifies a key displayed on the screen image that corresponds to the touched position, and executes a corresponding process (including display of a further setting screen image). The screen image for entering the personal identification number includes, for example, a message “Please enter your personal identification number,” ten keys and an area displaying the entered numerical value. If the personal identification number is entered, the second control unit 202 transmits the obtained residence registration code and the personal identification number to server computer 320. Using the received residence registration code and the personal identification number, server computer 320 executes authentication and transmits the result to extension apparatus 200 (second control unit 202). If the authentication fails, the second control unit 202 displays an indication to that effect on display panel 116. If the authentication succeeds, the second control unit 202 displays a screen image allowing designation of conditions for the copy of Certificate of Residence, on display panel 116. If the authentication fails, the control may be returned to step 500, or the screen image for entering the personal identification number may be displayed again to allow input of personal identification number again.

The conditions for Certificate of Residence may include which certificate for the applicant in person, for all members of the family, or for partial members of the family is requested, whether the name of house holder, relationship to the house holder, legal domicile and the head of family are to be stated, and the necessary number of copies. Thus, a screen image for designating these items is transmitted from extension apparatus 200 to image forming apparatus 100 and displayed on display panel 116. The second control unit 202 calculates necessary fee in accordance with the conditions of Certificate of Residence, and displays a screen image including the fee and a message asking the user to charge money to a coin slot 242 or a bill inserting slit 244 (see FIG. 2), on display panel 116.

At step 686, the second control unit 202 determines whether the necessary fee is paid. If it is determined to be paid, the control proceeds to step 688. Otherwise, the control returns to step 684.

At step 688, the second control unit 202 obtains image data from server computer 320 and executes a print process. Specifically, the second control unit 202 transmits data requesting image data of a copy of Certificate of Residence (hereinafter referred to as “request for Certificate of Residence data”) to server computer 320. The request for Certificate of Residence data includes the residence registration code, the conditions for the copy of Certificate of Residence and information of transmission destination address. The information of transmission destination address is the network address of image forming apparatus 100 (IP address of NIC as the first network I/F unit 122). Using the received residence registration code, server computer 320 searches a database, using obtained data, generates an image data matching the received conditions of the copy of Certificate of Residence, and transmits the generated data to the received transmission destination address, that is, to the image forming apparatus 100. The first control unit 102 of image forming apparatus 100 forms the image data (copy of Certificate of Residence) received from server computer 320 on a sheet of prescribed recording paper (for example, a sheet of A4 size), and discharges it to discharge tray 140. Thereafter, the control returns to step 500. If more than necessary money is input, the second control unit 202 discharges changes to change extraction port 246, and then, the control returns to step 500.

As described above, by the series of operations shown in FIGS. 5 and 6, when the service of copying a document, scanning a document, printing image data stored in a portable storage medium or printing Certificate of Residence is provided to a user, it is possible to stop power supply to components of the image formation system not related to the service. Therefore, the present image formation system can reduce power consumption without causing any trouble in providing services to the user.

At the time point when the user touches COPY key 724, SCAN key 726 or CERTIFICATE OF RESIDENCE PRINT key 730 on the service selection screen image 720 shown in FIG. 8, the operational mode of image formation system (image forming apparatus 100) is determined and, therefore, it is possible to determine power supply to which unit or units should be stopped. On the other hand, when PHOTO PRINT key 728 is touched, the operational mode is not yet determined and power is supplied to all components. The operational mode is determined when the user designates the size of recording paper on print type selection screen image 740 shown in FIG. 9, and the first image forming unit 108 of image forming apparatus 100 or the second image forming unit 210 of extension apparatus 200 is set to the power saving mode. Thus, the service selection menu (operation screen image) is provided in a hierarchical manner and when determination is made as to which image forming unit is used, the corresponding image forming unit is set to the power saving state. Therefore, it is possible to provide the user with a hierarchical guide of method of operation, and hence, a system that realizes both the improved usability and reduced power consumption can be provided.

The flowchart shown in FIGS. 5 and 6 may be executed with various modifications. By way of example, at each step, the subject in charge of generation of the screen image (image) to be displayed on display panel 116 and detection of a touch operation on touch-panel 118 may be appropriately changed (first or second control unit 102 or 202).

The screen images to be displayed on display panel 116 may be all generated by the first control unit 102 or all generated by the second control unit 202. If all the images are to be generated by the first control unit 102, the second control unit 202 transmits information necessary for generating the screen images to the first control unit 102. Further, the first control unit 102 or the second control unit 202 may be adapted to detect all operations on touch-panel 118. If a process corresponding to a touch detected by one of the first and second control units 102 and 202 is to be executed by the other one of the control units, necessary information for the process should be transmitted from the one to the other control unit.

By way of example, at step 502, the first control unit 102 may cause the screen image generating unit to generate energy saving standby screen image 700 to be displayed on display panel 116. At step 504, the first control unit 102 may determine whether or not service start key 704 displayed on display panel 116 is touched. In that case, at step 506, the first control unit 102 transmits the return code to the second control unit 202.

Though an example in which server computer 320 transmits image data of a copy of Certificate of Residence to image forming apparatus 100 has been described above, it is not limiting. Server computer 320 may transmit the image data of a copy of Certificate of Residence to extension apparatus 200, and then extension apparatus 200 may generate a print job using the received image data and transmit it to image forming apparatus 100. In that case, the transmission destination address included in the request for Certificate of Residence data transmitted from the second control unit 202 to server computer 320 is the address of extension apparatus 200 (for example, IP address of NIC as the second network I/F unit 220).

In the foregoing, an example has been described in which the image formation system includes image forming apparatus 100 and extension apparatus 200 and the first and second control units 102 and 202 control the first and second image forming units 108 and 210, respectively. The example above, however, is not limiting. A configuration in which one control unit controls the first and second image forming units 108 and 210 may also be possible. For example, an image formation system may be configured by one control device for overall control of the image formation system and two image forming apparatuses. In that case, media reader unit 206, IC card reader 208 and operation unit 112 (display panel 116 and touch-panel 118) may be provided on either one of the image forming apparatuses.

Further, the service provided by the present image formation system is not limited to the copy, scan, photo-print and printing of Certificate of Residence describe above. By way of example, a service of printing such as a seal registration certificate transmitted on-line from server computer 320 may be provided. If image forming apparatus 100 has a facsimile function, facsimile transmission service may be provided. Further, a function of printing image data up-loaded to a prescribed server computer from a computer connected to the Internet may be provided.

The size of recording paper is not limited to those described above. What matters is that sheets of paper used are of different types between the apparatuses (image forming apparatus 100 and extension apparatus 200). Specifically, the sheets of paper may be of different size, or of the same size but different quality (for example, plain paper and glossy paper).

Though an example in which power supply to each unit is stopped has been described above, it is not limiting. By way of example, in place of stopping power supply to the first image forming unit 108, power supply only to the fixing heater included in the first image forming unit 108 may be stopped. Further, in place of stopping power supply to the second image forming unit 210, power supply only to the heater heating an ink ribbon having solid ink applied thereon, included in the second image forming unit 210 (dye-sublimation type printer), may be stopped.

Though an example in which image data to be printed is exchanged between extension apparatus 200 and image forming apparatus 100 through network 310 has been described above, it is not limiting. The image data may be exchanged directly, not through network 310. By way of example, if extension apparatus 200 and image forming apparatus 100 have USB interfaces, the image data may be directly exchanged using a USB cable. Further, image data to be displayed on the display panel may also be transmitted through USB interface from extension apparatus 200 to image forming apparatus 100.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

According to the present invention, an image formation system capable of reducing power consumption without sacrificing user convenience can be provided.

### DESCRIPTION OF THE REFERENCE SIGNS

100 image forming apparatus
200 extension apparatus
300 router
320 server computer
310 network
312 Internet
102 first control unit
104 first storage unit
106 document reading unit
108 first image forming unit
110 first power supply unit
112 operation unit
114 first video I/F unit
116 display panel
118 touch-panel
120 first serial I/F unit
122 first network I/F unit
202 second control unit
204 second storage unit
206 media reader unit
208 IC card reader
210 second image forming unit
212 second power supply unit
214 drawing unit
216 second video I/F unit
218 second serial I/F unit
220 second network I/F unit

1. An image formation system, comprising:
first and second image forming units forming an image on recording paper;
a control unit controlling said first and second image forming units; and
an input unit receiving an instruction from a user; wherein
while said first and second image forming units are in a power saving state, in response to said input unit receiving an image formation instruction as an instruction to form an image on the recording paper, said control unit returns said first and second image forming units from the power saving state to a normal power consumption state; and
after receiving said image formation instruction, when said input unit receives an indication of a condition related to the image formation, said control unit causes one of said first and second image forming units, which is not used for the image formation executed in accordance with said indication of the condition, to enter the power saving state.

2. The image formation system according to claim 1, wherein
said control unit includes a display unit for displaying an image and a detecting unit for detecting a user operation to said image displayed on said display unit;
said control unit receives said indication of the condition by successively displaying a plurality of images on said display unit and detecting a user operation by said detecting unit; and
at a time point when one of said first and second image forming units which is not used for the image formation is determined, said control unit causes the determined image forming unit to enter the power saving state.

3. The image formation system according to claim 1, further comprising
a providing unit for providing image data to be used for image formation by said first and second image forming units; wherein
said control unit controls power consumption state of said providing unit;
while said providing unit is in the power saving state, in response to said input unit receiving said image formation instruction, said control unit returns said providing unit to the normal power consumption state; and
after receiving said image formation instruction, when said input unit receives said indication of the condition, said control unit selectively executes, depending on necessity of said providing unit in image formation in accordance with said indication of the condition, a process of maintaining said providing unit in the normal power consumption state or a process of causing said providing unit to enter the power saving state.

4. The image formation system according to claim 3, wherein said providing unit is a document reading unit reading a document and thereby generating image data, or a reading unit reading image data from a storage medium storing the image data.

5. The image formation system according to claim 1, further comprising
an IC card reader; wherein
said control unit controls power consumption state of said IC card reader;
while said IC card reader is in the power saving state, in response to said input unit receiving said image formation instruction, said control unit returns said IC card reader to the normal power consumption state; and
after receiving said image formation instruction, when said input unit receives said indication of the condition, said control unit selectively executes, depending on necessity of said IC card reader in image formation in accordance with said indication of the condition, a process of maintaining said IC card reader in the normal power consumption state or a process of causing said IC card reader to enter the power saving state.

6. The image formation system according to claim 1, wherein
said first and second image forming units use recording paper of mutually different sizes in image formation; and
after receiving said image formation instruction, when said input unit receives said indication of the condition, said control unit determines the size from said indication of the condition, and causes one of said first and second image forming units which does not use the recording paper of the determined size to enter the power saving state.
